(19) United States
(12) Patent Application Publication
(10) Pub. No.: US 2004/0226540 A1
(43) Pub. Date: Nov. 18, 2004

(54) High pressure reservoir for fuel injection of internal combustion engines with a high-pressure fuel pump

(76) Inventors: Henning Kreschel, Ludwigsburg (DE); Markus Degn, Altmuenster (AT)

Correspondence Address: RONALD E. GREIGG, GREIGG & GREIGG P.L.L.C., Suite One, 1423 Powhatan Street, Alexandria, VA, 22314, US

(21) Appl. No.: 10/745,574

(22) Filed: Dec. 29, 2003

(30) Foreign Application Priority Data
Dec. 30, 2002 (DE) 1 02 61 737.6

(51) Int. Cl. F02M 1/00

(52) U.S. Cl. 123/456

(57) ABSTRACT

The invention relates to a component to be loaded with internal pressure, which in its interior has various bores that intersect one another. In particular, such components are used in the field of so-called common rails. Since in fuel injection systems these components are not only under very high internal pressure but the internal pressure is moreover subject to periodically severe fluctuations, correspondingly stringent demands in terms of strength must be made. By geometrically optimizing the intersection region of the bore of the high-pressure fuel reservoir and the bore for the connection, the result in cross section is an elliptical design. By embodying the bore intersection as an ellipse, the stresses in these local regions can be reduced, and as a consequence the permissible internal pressure can intrinsically be increased.

### BACKGROUND OF THE INVENTION

1. Field of the Invention

The invention relates to a component to be loaded with internal pressure, in particular in the embodiment of a high-pressure fuel reservoir, for fuel injection for internal combustion engines with a high-pressure fuel pump suitable for supplying the high-pressure fuel reservoir with fuel, in which the high-pressure fuel reservoir comprises an elongated tubular body with an inner bore and with connections to bores for supply and removal of fuel, and the bores intersect one another.

2. Description of the Prior Art

Particularly in so-called reservoir injections (common rail systems), which are used in the field of fuel injection technology in internal combustion engines, components loaded with internal pressures in particular are required. Such components are used for high-pressure reservoirs (rails) and injectors. These components of the fuel injection system are not only under very high internal pressure but are moreover subject to periodically severe fluctuations in the internal pressure (so-called swelling internal pressure). Such components must therefore meet correspondingly stringent demands for strength. In particular, the strength of the bore intersections in the interior of the high-pressure reservoir is of primary importance.

### OBJECT AND SUMMARY OF THE INVENTION

The object of the invention is to create a further enhancement in strength of bore intersections in components of this type, particularly with respect to the incident internal pressure loads.

The object is attained by designing the cross section of the bore intersections elliptically, so that at the point of maximum stress, a locally long radius exists for the distribution of the incident pressure stress.

One essential advantage of the invention is that because of the particular type of design of the inner bores that intersect one another, a cross section is created in which the stress in the region of the cross section is reduced, making it possible to increase the efficiency, especially if a fuel injection system, in which the allowable internal pressure—particularly of the high-pressure reservoir (rail)—can be increased.

Because of the simple arrangement of the corresponding bores of the high-pressure fuel reservoir and its connections, higher efficiency can be attained without additional cost.

The embodiment for attaining a bore intersection of elliptical cross section can be attained in various ways.

In a preferred embodiment, the high-pressure fuel reservoir has a virtually rectangular cross section with rounded corners, in which a connection with a cylindrical bore discharges in such a way that the angle between a vertical plane containing the axis of the reservoir and the axial direction of the connection is greater than 0°. As a result, an elliptical cross section is attained in the bore intersection region.

The embodiments of the connection, because of the simple design, can for instance be welded. Alternatively, the connection to the high-pressure fuel reservoir can be forged.

Because of the simple design, it is also possible to arbitrarily shape the cross section of the high-pressure fuel reservoir inner bore; in particular, it can be disposed either centrally or eccentrically to the outer contour. There is also the freedom of having the connection bore discharge centrally or eccentrically to the inner bore, depending on what connection is needed in the installed state of the high-pressure fuel reservoir.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a cross section through a first exemplary embodiment of a high-pressure reservoir with a connection;

FIG. 2 is a section through the high-pressure reservoir of FIG. 1 taken along a line II-II;

FIG. 3 is a cross section through a second exemplary embodiment of a high-pressure reservoir with a connection;

FIG. 4 is a section through the high-pressure reservoir of FIG. 3 taken along a line IV-IV;

FIG. 5 is a cross section through a third exemplary embodiment of a high-pressure reservoir with a connection; and

FIG. 6 is a section through the high-pressure reservoir of FIG. 5 taken along a line VI-VI.

### DESCRIPTION OF THE PREFERRED EMBODIMENTS

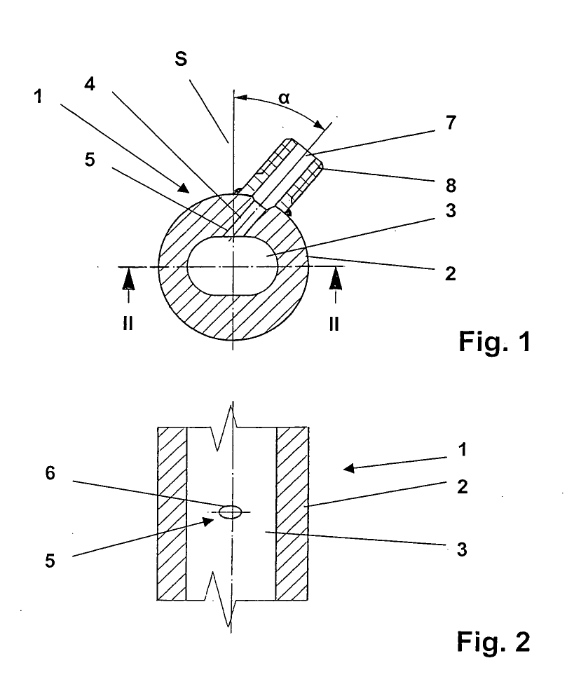

In FIG. 1, a component 1 to be loaded with internal pressure is shown in cross section; it has an intrinsically arbitrary outer contour 2. The bore 3 disposed in the component 1 extends longitudinally of the component 1 and is continuous. The bore 3 has an oblong cross section, with generally semicircular ends. A second or connecting bore 4 discharges into the bore 3 and forms an intersection region 5. The connecting bore 4 has a circular cross section and has its longitudinal axis offset from the axis of the inner bore 3 and disposed at an angle a to the vertical S, and extends obliquely into the bore 3, creating an elliptical cross section 6, as shown in FIG. 2, in the intersection region 5.

In the exemplary embodiment shown in FIG. 1, a connection 8 is provided, which likewise has a cylindrical bore 7 that is aligned with the further cylindrical bore 4. The connection 8, in the exemplary embodiment shown in FIG. 1, is welded to the outer contour 2 of the component 1.

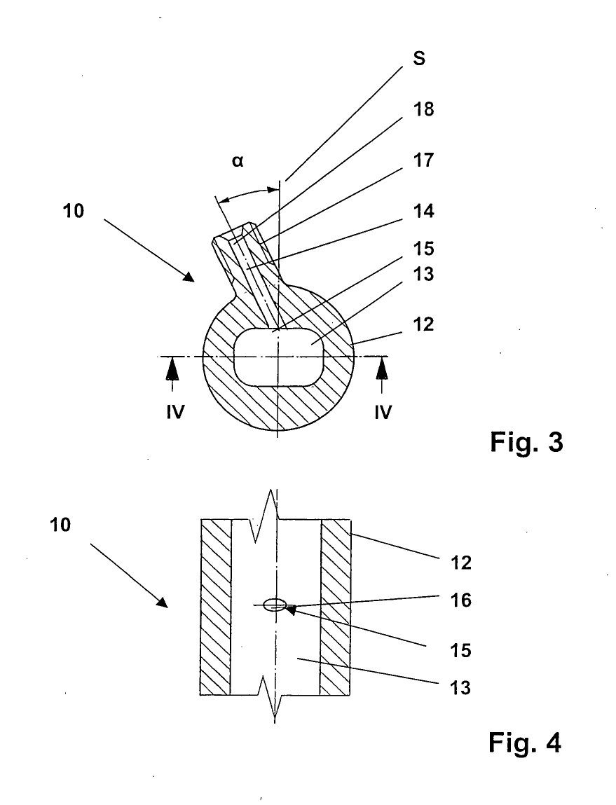

In the exemplary embodiment of a component 10 shown in FIG. 3, once again an outer contour 12 that is intrinsically arbitrary is provided, in this case a circular outer contour. In the interior of the component 10, there is a bore 13 of substantially rectangular cross section with rounded corners, which likewise extends continuously in the longitudinal direction of the component 10. A further bore 14 is also provided in a forged connection 17 formed on component 10, with its axis at an angle a to the vertical S, and discharging into the bore 13 in an intersection region 15. The axis of bore 14 is offset from the axis of bore 13.

Because of the oblique discharge of the bore 14, the intersection region 15 is shaped elliptically, as shown in FIG. 4.

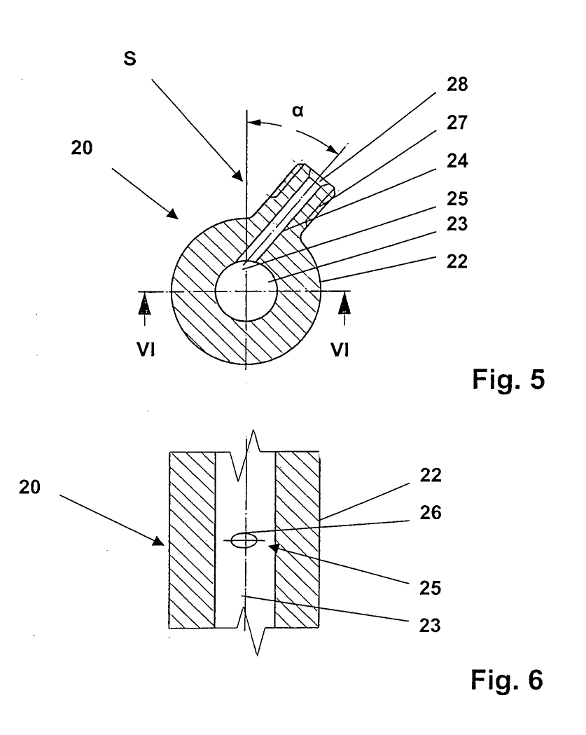

In the exemplary embodiment of a component 20 shown in FIG. 5, once again an intrinsically arbitrary outer contour 22 is provided, and in addition, a bore 23 of circular cross section designed to be continuous in the component. This bore 23 is shown as disposed centrally to the outer contour 22 but may be offset with respect there. In addition, a further bore 24 is provided, which discharges from outside into the bore 23. The axis of bore 24 is offset from the axis of the bore 23 and extends at an angle a greater than 0° to the vertical S, so that in the intersection region 25, an elliptical cross section 26 is created, as shown in FIG. 6.

The invention can be used in all components loaded with internal pressure that have bore intersections, such as rails, injectors, pumps, or the like.

The foregoing relates to preferred exemplary embodiments of the invention, it being understood that other variants and embodiments thereof are possible within the spirit and scope of the invention, the latter being defined by the appended claims.

We claim:

1. A high-pressure fuel reservoir for fuel injection for internal combustion engines with a high-pressure fuel pump suitable for supplying the high-pressure fuel reservoir with fuel, the high-pressure fuel reservoir comprising
an elongated tubular body
an inner bore extending longitudinally of the tubular body, and
inlet and outlet bores for supply and removal of fuel from the inner bore, the inner bore and the inlet and outlet bores (3, 4; 13,14; 23, 24) intersecting at an intersection region (6; 16; 26) in a manner to provide an elliptical cross section (6; 16; 26) of the intersection region (6; 16; 26).

2. The fuel reservoir according to claim 1, wherein the bore (3; 13; 23) of the component (1; 10; 20) is embodied in flattened fashion in the region of the intersection (5; 15; 25), and the cylindrically embodied bore (4; 14; 24) of the connection (7; 17; 27) discharges at an angle greater than 0° to the vertical (S).

3. The fuel reservoir according to claim 1, wherein the bore (3; 13; 23) of the fuel reservoir (1; 10; 20) is embodied as round in the region of the intersection (5; 15; 25), and the cylindrically embodied bore (4; 14; 24) of the connection (7; 17; 27) is offset from the axis of the bore (3; 13; 23) of the reservoir and discharges at an angle greater than 0° to the vertical (S).

4. The fuel reservoir according to claim 1, wherein in the bore (4; 14; 24) of the connection (7; 17; 27) discharges centrally to the bore of the fuel reservoir (1; 10; 20).

5. The fuel reservoir according to claim 2, wherein in the bore (4; 14; 24) of the connection (7; 17; 27) discharges centrally to the bore of the fuel reservoir (1; 10; 20).

6. The fuel reservoir according to claim 3, wherein in the bore (4; 14; 24) of the connection (7; 17; 27) discharges centrally to the bore of the fuel reservoir (1; 10; 20).

7. The component according to claim 1, wherein in the bore (4; 14; 24) of the connection (7; 17; 27) discharges eccentrically to the bore (3; 13; 23) of the component (1; 10; 20).

8. The component according to claim 2, wherein in the bore (4; 14; 24) of the connection (7; 17; 27) discharges eccentrically to the bore (3; 13; 23) of the component (1; 10; 20).

9. The component according to claim 3, wherein in the bore (4; 14; 24) of the connection (7; 17; 27) discharges eccentrically to the bore (3; 13; 23) of the component (1; 10; 20).
